(19) United States
(12) Patent Application Publication
(10) Pub. No.: US 2026/0188089 A1
(43) Pub. Date: Jul. 2, 2026

(54) USING SOUND FOR IDENTIFICATION OF A SENSOR OR SENSOR TRIGGERING EVENT IN A SECURITY SYSTEM

(71) Applicant: The ADT Security Corporation, Boca Raton, FL (US)

(72) Inventor: Charbel HAYEK, Boca Raton, FL (US)

(21) Appl. No.: 19/006,795

(22) Filed: Dec. 31, 2024

(51) Int. Cl. G08B 3/10; G08B 13/16; G10L 25/51

(52) U.S. Cl. CPC G08B 3/10; G08B 13/1672; G10L 25/51

(57) ABSTRACT

The present disclosure describes a security system that identifies a sensor and/or a sensor triggering event based on a sound that the sensor produces. The security system includes a microphone, one or more memories, and one or more processors communicatively coupled to the one or more memories. The one or more processors, individually or collectively, perform an operation that includes capturing a first sound using the microphone, and after linking the first sound to the sensor and a triggering event for the sensor, detecting, using the microphone, a second sound, determining, by comparing the second sound to the first sound, that the second sound is produced by the sensor, and in response to determining that the second sound is produced by the sensor, generating a reporting event based on the triggering of the sensor.

### TECHNICAL FIELD

Embodiments presented in this disclosure generally relate to identification of a sensor and more specifically, to using recorded audio produced by a sensor to identify the sensor or a sensor triggering event.

### BACKGROUND

Security systems typically include multiple types of sensors that detect events in an environment (e.g., a home, office, store, etc.) or a trouble condition or error with the sensor itself (e.g., a fault or a low battery). For example, the systems may include access sensors, temperature sensors, motion sensors, etc. Existing security systems, however, are often not interoperable with sensors designed or manufactured by other parties, which may be referred to as third-party sensors. As a result, when these sensors trigger (e.g., by detecting alarm events, experiencing n fault, low battery, or other error / trouble condition), the sensors may not properly inform a security system of the trigger condition, and the security system may not generate an alarm event or other reporting corresponding to the triggered sensors. As a result, the detected events may not be properly reported by the security system.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example security system, according to one embodiment.

FIG. 1B illustrates an example security hub or remote keypad of the security system of FIG. 1A, according to one embodiment.

FIG. 2 illustrates an example operation performed by the security system of FIG. 1A, according to one embodiment.

FIG. 3A illustrates an example operation performed by the security system of FIG. 1A, according to one embodiment.

FIG. 3B illustrates an example operation performed by the security system of FIG. 1A, according to one embodiment.

FIG. 4 illustrates an example operation performed by the security system of FIG. 1A, according to one embodiment.

FIG. 5 illustrates an example operation performed by the security system of FIG. 1A, according to one embodiment.

FIG. 6 is a flowchart of an example method performed by the security system of FIG. 1A, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF DISCLOSED EMBODIMENTS

### Overview

The present disclosure describes a security system that identifies a sensor and/or a sensor triggering event based on a sound that the sensor produces. According to an embodiment, a security system includes a microphone, one or more memories, and one or more processors communicatively coupled to the one or more memories. The one or more processors, individually or collectively, perform an operation that includes capturing a first sound using the microphone, and after linking the first sound to the sensor and a triggering event for the sensor, detecting, using the microphone, a second sound, determining, by comparing the second sound to the first sound, that the second sound is produced by the sensor, and in response to determining that the second sound is produced by the sensor, generating a reporting event based on the triggering of the sensor.

According to another embodiment, a method includes capturing, using a microphone, a first sound produced by a sensor, linking the first sound to the sensor, detecting, using the microphone and after linking the first sound to the sensor and a triggering event for the sensor, a second sound, determining, by comparing the second sound to the first sound, that the second sound is produced by the sensor, and in response to determining that the second sound is produced by the sensor, generating a reporting event based on the triggering of the sensor.

According to another embodiment, a method includes capturing, using a microphone, a first sound produced by a sensor, linking the first sound to the sensor, detecting, using the microphone and after linking the first sound to the sensor and a triggering event for the sensor, a second sound, determining, by comparing the second sound to the first sound that the second sound is produced by the sensor and that the sensor is experiencing an error, and, in response, generating a reporting event based on the sensor error.

According to another embodiment, a non-transitory computer readable medium stores instructions that, when performed by one or more processors, cause the one or more processors to, individually or collectively, perform an operation that includes capturing, using a microphone, a first sound, comparing the first sound to a recording of a second sound produced by a sensor to determine that the second sound is produced by a triggering of the sensor by a triggering event, and in response to determining that the second sound is produced by the triggering of the sensor, generating a reporting event based on the triggering of the sensor.

### EXAMPLE EMBODIMENTS

The present disclosure describes a security system (e.g., a home or business security system) that uses sounds produced by sensors to identify the sensors and/or a sensor triggering event (such as activation of the sensor as an alarm event, or a trouble condition, such as a fault, low battery, etc.). The security system may use a microphone to capture a sound produced by a sensor. The security system may then record the sound and link the recorded sound to the sensor and the information conveyed by that sound. When the sensor produces a sound, the security system may detect the sound and compare the detected sound against previous recordings. When the security system determines a matching or similar sound in the recordings, the security system may use the matching or similar recording to identify the sensor that produced the sound. The security system may then generate a reporting event based on the nature of sensor and/or the state of the security system (e.g., an alarm event for a smoke detector or for a motion sensor when the security system is armed). The reporting event may indicate that the identified sensor triggered. The security system may also use the sound itself to determine the nature of the triggering event, such as whether the sensor was an alarm event, or some other reportable event, like a trouble condition with the sensor itself (such as a fault or low battery condition).

In certain embodiments, the security system provides several technical advantages. For example, the security system may detect when a sensor triggered even though the sensor cannot be directly enrolled with the security system (e.g., because the sensor is a third-party sensor). As a result, the security system may detect when certain sensors trigger, whereas existing security systems do not report when these sensors trigger.

As an example, some sensors (e.g., smoke detectors, carbon monoxide detectors, moisture sensors, etc.) may be developed by third parties and may be unable to operate with a security system. For example, these sensors may not be designed for enrollment or interoperation with that particular security system, or may not be fully compatible with that system). As a result, when one of these sensors trigger (or otherwise may need to communicate their state), the sensor may not properly communicate signals to the security system. Nevertheless, the security system may determine that the sensor triggered using a sound produced by the sensor. For example, when a smoke detector is installed, the smoke detector may be tested, which causes the smoke detector to produce a sound. The security system may detect the sound and generate a recording of the sound. The security system may then request user input to provide information about the smoke detector (e.g., to identify the smoke detector or to provide an image of the smoke detector). After the information is provided, the security system links the recording of the sound with the information. As another example, a smoke detector may “chirp” when it experiences a low battery, fault, or other trouble condition. The sensor may also be capable of testing for these conditions. The security system may detect the chirp and the chirp may linked with the smoke detector and the condition for the smoke detector.

Subsequently, when the smoke detector triggers, the smoke detector produces a sound. The security system detects the sound and compares the sound with the stored recordings of sensor sounds. The security system may determine that the recording of the smoke detector is the most similar or matches the sound produced by the smoke detector. In response, the security system determines that the smoke detector is triggering and communicates alerts indicating that the smoke detector is triggering. In this manner, the security system detects when the smoke detector triggers even though the smoke detector is not registered to the security system. If the detected sound is a chirp that matches or is similar to the previously stored chirp of the smoke detector, the security system may determine that the smoke detector is experiencing the condition linked to the recorded chirp (e.g., low battery, fault, etc.). The security system may then communicate an alert indicating the condition experienced by the smoke detector.

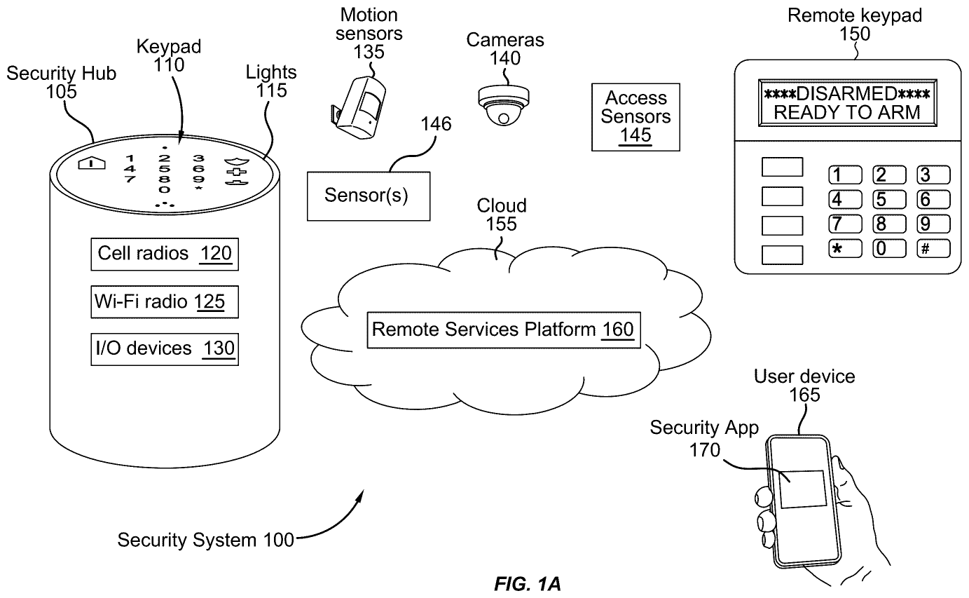

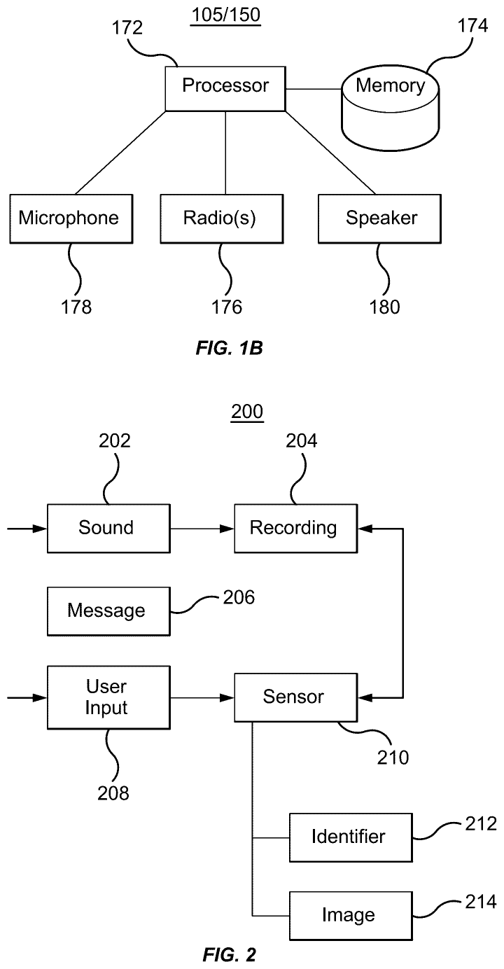

FIG. 1A illustrates a security system 100, according to one embodiment. The security system 100 includes a security hub 105, motion sensors 135, cameras 140, access sensors 145, one or more sensor 146, and a remote keypad 150. FIG. 1A also illustrates a cloud computing environment 155 and a user device 165, which can be used to remotely control the various devices in the security system 100.

The security hub 105 includes a keypad 110, lights 115, cell radios 120, a Wi-Fi radio 125, and input/output (I/O) devices 130. In this example, the security hub 105 is a device (e.g., a cylinder, box, or alarm panel) that can communicate with the other devices in the security system 100 such as the motion sensors 135, cameras 140, access sensors 145, sensor(s) 146, and the remote keypad 150. As shown, the security hub 105 communicates wirelessly with these devices, but in other implementations, could have wired connections to the devices.

In one embodiment, the security hub 105 serves as a bridge between the devices in the security system 100 and a remote services platform 160 in the cloud 155. For example, the security hub 105 may use its Wi-Fi radio 125 (or another type of radio such as a Bluetooth low energy (BLE) radio) to communicate with the motion sensors 135, cameras 140, access sensors 145, and/or sensors 146. Data collected from these devices can then be relayed to the remote services platform 160 using a local Wi-Fi network or a cellular network using the Wi-Fi radio 125 or one of the cell radios 120. However, in another embodiment, these devices can communicate with the remote services platform 160 without using the security hub 105. For instance, the cameras 140 may have their own Wi-Fi connection to the platform 160 via the local Wi-Fi network. In one embodiment, the devices in the security system 100 can be Internet of Things (IoT) devices.

The security hub 105 includes a keypad 110 that the user can use to input a code to arm or disarm the security system 100. The lights 115 may provide feedback indications or instructions to the user. For example, when a user enters a home and triggers one of the access sensors 145, the hub 105 may flash orange indicating that the user should provide the code within a set time period. If the code is entered correctly, the lights 115 may turn green. If the code is entered incorrectly, the lights 115 may turn red.

In addition to the lights 115, the hub 105 may include other input/output (I/O) devices 130 such as a speaker, a microphone, additional lights, a camera, fingerprint scanner, etc. The I/O devices 130 can be used to provide commands as well as sense user input, such as a code phrase, perform a face scan, scan a thumbprint, or capture images of the environment.

The security hub 105 can include any number of processors (e.g., central processing units or application specific integrated circuits) and memory for performing the functions described herein. For instance, the processor and memory may include software applications for communicating with the devices in the security system 100, communicating with the remote services platform 160, authenticating a user, performing voice recognition, performing facial scans, and the like.

The hub 105 may use the cell radios 120 as backup radios if the local Wi-Fi network is unavailable. For example, when power is lost, the Wi-Fi network may turn off. However, the hub 105 (which may include its own backup battery) may use the cell radios 120 to maintain communication with the remote services platform 160, such as receiving commands or informing the platform 160 if there is an intruder. Because power loss or natural disasters may also affect cell networks, the hub 105 may include multiple cell radios 120 for different cell networks. This redundancy may ensure that the hub 105 may continue to communicate with emergency services via the platform 160.

The motion sensors 135, cameras 140, and/or the access sensors 145 may be placed to monitor or guard points (e.g., entry points) at the location to detect (or prevent) entry of an unauthorized person. For example, the access sensors 145 can be placed on windows and doors to alert the security hub 105 when a window or door is opened when the security system 100 is armed, or the access sensors 145 may detect glass breaking or other sounds of an intrusion.

The sensors 146 may include any types of sensors, including temperature sensors, humidity sensors, moisture sensors, smoke detectors, occupancy sensors, carbon monoxide detectors, etc. These sensors 146 may be positioned throughout the location to detect different states of the location. For example, the sensors 146 may detect the temperature of the location, the humidity of the location, and/or the presence of moisture, smoke, people, or carbon monoxide at the location. Generally, the motion sensors 135, cameras 140, and/or access sensors 145 are also considered sensors 146 but have been illustrated separately in FIG. 1A for clarity.

One or more remote keypads 150 may be disposed at the location. For example, while the security hub 105 may be located at a main entrance (in which case a user could use the keypad 110 on the security hub 105 to arm or disarm the system 100), the remote keypad 150 may be located at a back or side door. As such, the remote keypad 150 may be optional and the user may rely solely on the security hub 105 to arm and disarm the system 100. In another example, the security hub 105 may not include the keypad 110, in which case one or more remote keypads 150 can be used to arm and disarm the system 100. For example, the user may input a code on the remote keypad 150, which then relays the code to the security hub 105. The security hub 105 may determine if the code is correct and disarm the various devices in the security system 100. In another embodiment, the hub 105 may forward the code to the remote service platform 160, which verifies the code and instructs the hub 105 to disarm the system 100.

As mentioned above, the remote services platform 160 serves as a portal to enable a user to remotely monitor and control the security system 100. In this example, the user device 165 (e.g., a smartphone, tablet, laptop, etc.) executes a security application 170 (e.g., ADT+) that allows the user to interact with the security system 100. For example, if the user forgot to disarm the security system 100 when leaving for work, the user can use the security application 170 to instruct the platform 160 to arm the system. As another example, if a person wants to enter the premises when the user is not present, the user can disarm the security system 100 without having to provide the code to the person. Moreover, the remote services platform 160 may enable the user to stream the feeds of the cameras 140 to the user device 165. Also, the user may perform administrative tasks using the security application 170, such as registering new devices, changing the code or technique used to arm/disarm the system 100, paying subscriptions, and the like.

In one embodiment, the security application 170 is provided by the same company or vendor that provides the physical devices in the security system 100 (e.g., the security hub 105 and various other sensors). However, the security application 170 could be a third-party application, such as an application that works across vendors.

The cloud 155 may include compute resources in one or more data centers. The platform 160 may be implemented in the cloud 155 in one data center, or multiple data centers in various geographical locations. The platform 160 may store the configuration information for the user and the security system 100. For example, the platform 160 may register the various devices in the security system 100 and monitor the outputs generated by these devices (when provided by the hub 105). The security hub 105 may detect when a new device (e.g., a new sensor) has been added to the system 100 and inform the platform 160. In turn, the platform 160 may push an alert to the security application 170 and walk the user through a process to register the new device.

In some instances, some sensors may not register with an existing security hub and/or an existing security system. For example, some third-party sensors may not be compatible with the security hub or security system. Because the sensors cannot register with the security hub or security system, the security hub or security system may not detect when the sensors trigger. As a result, the security hub or security system may not generate events (e.g., alarm events) when the sensors trigger.

During a formal enrollment and registration process, using sensors that are formally compatible with the security system, a sensor may communicate information about the sensor using a protocol or standard that the security hub or security system recognizes and understands, and vice versa. In this manner, the sensor and the security hub or security system establish a formal way of communicating with each other. For example, the sensor may communicate a message that includes an identifier, a network address, a key, or any other information that would serve to identify the sensor. The security hub or security system may then store the information about the sensor. The security hub or security system may also communicate information about the security hub or security system to the sensor (e.g., identifiers, network addresses, keys, etc.). The sensor may store this information about the security hub or security system. When the sensor subsequently triggers, the sensor may use the information from the security hub or security system to communicate messages to the security hub or the security system. These messages may include the identifier, the network address, the key, or the other information that identifies the sensor. The security hub or the security system may then determine that the sensor triggered using the information in the messages.

When a sensor is not enrolled and registered with the security hub or the security system, the sensor may not establish a formal way of communicating with the security hub or security system. For example, the sensor may not be provided identifiers, network addresses, or keys that the sensor may use to communicate messages to the security hub or security system. As a result, when the sensor triggers, the sensor may not communicate messages to the security hub or security system indicating that the sensor triggered. Consequently, the security hub or security system may also not detect when the sensor triggers.

The security system 100 uses sounds produced by these sensors to identify the sensors. For example, the security system 100 may compare a sound produced by a sensor to previous recordings of detected sounds. These recordings may be linked to sensors that are not registered with the security system. The security system 100 may determine a matching or similar recorded sound and identify the sensor using the information about the sensor linked to the recorded sound. The security system 100 may then generate an event that identifies the sensor that triggered, even though that sensor is not registered with the security system 100.

FIG. 1B illustrates an example security hub 105 or remote keypad 150 of the security system of FIG. 1A, according to one embodiment. As seen in FIG. 1B, the security hub 105 or remote keypad 150 includes a processor 172, a memory 174, one or more radios 176, a microphone 178, and a speaker 180. Generally, the processor 172 and the memory 174 may control the operation of the security hub 105 or the remote keypad 150.

The processor 172 is any electronic circuitry, including, but not limited to one or a combination of microprocessors, microcontrollers, application specific integrated circuits (ASIC), application specific instruction set processor (ASIP), and/or state machines, that communicatively couples to the memory 174 and controls the operation of the security hub 105 or remote keypad 150. The processor 172 may be 8-bit, 16-bit, 32-bit, 64-bit or of any other suitable architecture. The processor 172 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 172 may include other hardware that operates software to control and process information. The processor 172 executes software stored on the memory 174 to perform any of the functions described herein. The processor 172 controls the operation and administration of the security hub 105 or remote keypad 150 by processing information (e.g., information received from the sensors 146, user device 165, and memory 174). The processor 172 is not limited to a single processing device and may encompass multiple processing devices contained in the same device or computer or distributed across multiple devices or computers. The processor 172 is considered to perform a set of functions or actions if the multiple processing devices collectively perform the set of functions or actions, even if different processing devices perform different functions or actions in the set.

The memory 174 may store, either permanently or temporarily, data, operational software, or other information for the processor 172. The memory 174 may include any one or a combination of volatile or non-volatile local or remote devices suitable for storing information. For example, the memory 174 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 174, a disk, a CD, or a flash drive. In particular embodiments, the software may include an application executable by the processor 172 to perform one or more of the functions described herein. The memory 174 is not limited to a single memory and may encompass multiple memories contained in the same device or computer or distributed across multiple devices or computers. The memory 174 is considered to store a set of data, operational software, or information if the multiple memories collectively store the set of data, operational software, or information, even if different memories store different portions of the data, operational software, or information in the set.

The radios 176 may communicate messages or information using different communication technologies. For example, the security hub 105 or remote keypad 150 may use one or more of the radios 176 for Wi-Fi communications or cellular communications. The security hub 105 or remote keypad 150 may use one or more of the radios 176 to transmit messages and one or more of the radios 176 to receive messages. The security hub 105 or remote keypad 150 may include any number of radios 176 to communicate using any number of communication technologies (e.g., Bluetooth, UWB, etc.).

The microphone 178 and speaker 180 may be audio devices included in the security hub 105 or remote keypad 150. Generally, the microphone 178 captures and records audio or sounds near or around the security hub 105 or remote keypad 150. The microphone 178 may include circuitry (e.g., an analog to digital converter) that converts the sensor's audio to an electrical signal (e.g., a digital signal). The microphone 178 then communicates the electrical signal to the processor 172. The speaker 180 receives electrical signals from the processor 172. The speaker 180 includes circuitry that converts the electrical audio signals into playback audio. The speaker 180 may then direct the playback audio to the environment around the security hub 105 or remote keypad 150.

FIG. 2 illustrates an example operation 200 performed by the security system 100 of FIG. 1A, according to one embodiment. A security hub or remote keypad (e.g., the security hub 105 or the remote keypad 150 shown in FIG. 1A) may perform the operation 200. For clarity, the security hub will be described as performing the operation 200, but it is understood that the remote keypad may also perform the operation 200. By performing the operation, the security hub records and links recorded audio with a sensor.

The security hub begins by detecting a sound 202. For example, when a senor (e.g., a third-party sensor that is not registered to the security hub) is being installed or tested, the security hub may be placed into a mode (e.g., a listening mode or an enrollment/registration mode) in which the security hub begins monitoring for sounds in the environment. The sensor may then be manually triggered such that the sensor produces the sound 202 (e.g., a siren, a chirp, etc.). The security hub may include a microphone that captures the sound 202 and converts the sound 202 into an electrical audio signal. The security hub may include digital filters that filter out or remove background noises so that these background noises are not mixed with or confused with the sound 202 produced by the sensor.

In some instances, it may not be possible to enroll the sensor with the security hub. For example, the sensor may be a third-party sensor that was not designed to enroll with the security system. As a result, when a sensor triggers, that sensor may not communicate an event to the security hub to indicate that the sensor triggered. The security system may still monitor whether the sensor triggered by recording and storing the sound 202 produced by the sensor.

The security hub generates a recording 204 of the sound 202. For example, the recording 204 may include a digital representation of the sound 202 and/or the electrical audio signal generated from the sound 202. The recording 204 may be a file that can be opened or played to reproduce the sound 202.

The security hub generates a message 206 indicating that the sound 202 was detected. The message 206 may also indicate that the sound 202 may have been produced by a sensor that was not enrolled to the security hub. Additionally, the message 206 may request that a user identify the sensor that produced the sound 202. The security hub may display the message 206 on a display of the security hub. Additionally, the security hub may communicate the message 206 to a user device (e.g., the user device 165 shown in FIG. 1A).

The security hub may receive user input 208 in response to the message 206. The user input 208 may be provided by operating input devices (e.g., buttons, touch panels, etc.) on the security hub or input devices on the user device. The user input 208 may indicate a sensor 210. For example, the user input 208 may provide an identifier 212 for the sensor 210 and/or an image 214 for the sensor 210. The security hub then links the identifier 212 and/or the image 214 for the sensor 210 to the recording 204. For example, the security hub may store the recording 204 along with the identifier 212 and/or the image 214. As another example, the security hub may use a data structure (e.g., a table) that indicates that the identifier 212 and/or the image 214 identify or show the sensor 210 that produced the sound 202 for the recording 204.

A user may provide the user input 208 and indicate the identifier 212 and/or image 214 using any suitable means. For example, the user may operate buttons or touch panels on the security hub to select the identifier 212 from a list of identifiers. As another example, the user may operate the buttons or touch panels to input the identifier 212. As another example, the user may use a user device (e.g., the user device 165 shown in FIG. 1A) to capture the image 214 of the sensor and to communicate the image 214 to the security hub.

In certain embodiments, by linking the identifier 212 and/or the image 214 to the recording 204, the security hub may identify the sensor 210 if the sensor 210 subsequently triggers based on the sound 202 that the sensor 210 produces. As a result, the operation 200 allows the security hub to detect when the sensor 210 triggers, even though the sensor 210 cannot be registered to the security hub (e.g., using a sensor identifier provided by the sensor OEM).

In some embodiments, the security hub links the recording 204 to the identifier 212 and/or the image 214 using a profile. The security hub may generate and store a profile for the sensor 210. The profile may include the information used to identify the sensor 210. For example, the profile may include the recording 204, the identifier 212, and/or the image 214. The profile (and the information in the profile) may then be subsequently used to determine if the sensor 210 triggered.

The user input 208 may also indicate a condition experienced by the sensor 210. For example, when the sound 202 is a chirp produced by the sensor 210, the user input 208 may also indicate a condition experienced by the sensor 210 and indicated by the chirp (e.g., low battery, fault, etc.). The security hub then links condition and the sensor 210 with the sound 202. As a result, the sound 202 may be subsequently used to identify the sensor 210 and the condition experienced by the sensor 210.

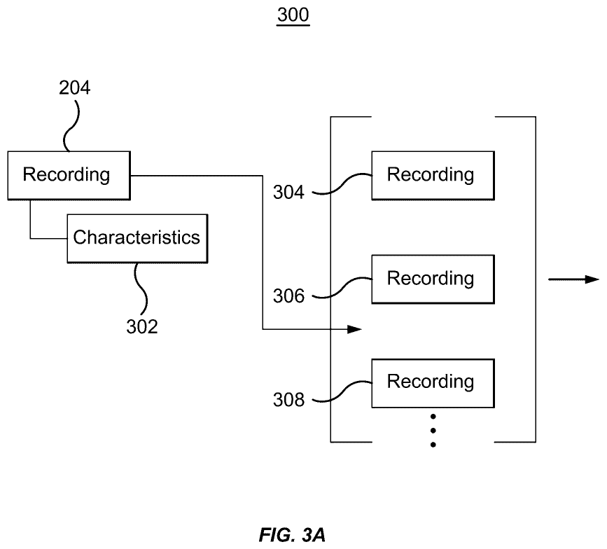

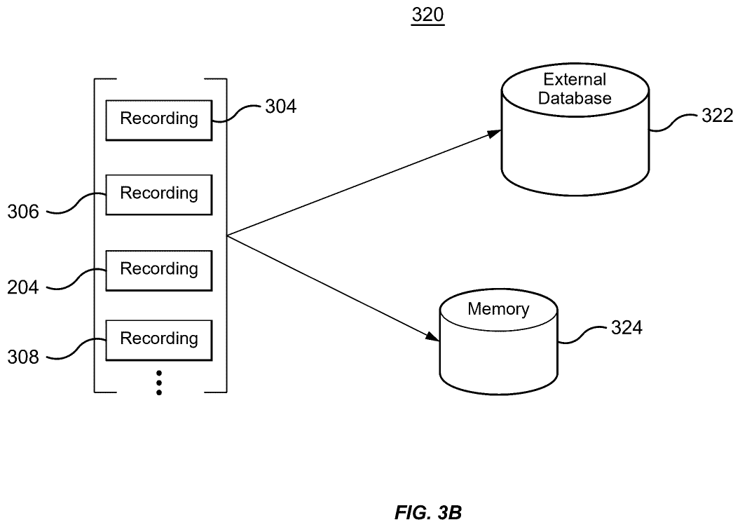

FIG. 3A illustrates an example operation 300 performed by the security system of FIG. 1A, according to one embodiment. A security hub or remote keypad (e.g., the security hub 105 or the remote keypad 150 shown in FIG. 1A) may perform the operation 300. For clarity, the security hub will be described as performing the operation 300, but it is understood that the remote keypad may also perform the operation 300. By performing the operation, the security hub sorts and stores a recording.

The security hub begins by generating the recording 204 of the sound produced by the sensor. For example, the security hub may use a microphone to capture the sound produced by the sensor, and the security hub may record the sound to generate the recording 204. The security hub may determine characteristics 302 of the sound in the recording 304. For example, the security hub may determine amplitudes and/or frequencies in the sound.

The security hub may then sort and store the recording 204 using the characteristics 302. For example, the security hub may store multiple recordings of sounds produced by different sensors. The security hub may organize or sort these recordings along with the recording 204 according to the characteristics. In the example of FIG. 3, the security hub also stores recordings 304, 306, and 308. The security hub may store these recordings 304, 306, and 308 according to one or more characteristics of the recordings 304, 306, and 308 (e.g., amplitude, frequency, etc.). The security hub sorts and stores the recording 204 with the recordings 304, 306, and 308 according to the characteristics 302. For example, if the security hub orders the recordings 304, 306, and 308 by frequency, then the security hub may store the recording 204 with the recordings 304, 306, and 308 to preserve the ordering of the frequencies. As another example, if the security hub orders the recordings 304, 306, and 308 by amplitude, then the security hub may store the recording 204 with the recordings 304, 306, and 308 to preserve the ordering of the amplitudes.

In the example of FIG. 3A, the security hub stores the recording 204 such that the recording 204 is sorted between the recording 306 and the recording 308. For example, the recording 204 may have a frequency that is between the frequencies of the recordings 306 and 308. As another example, the recording 204 may have an amplitude that is between the amplitudes of the recordings 306 and 308.

In certain embodiments, the security hub stores the recordings 204, 304, 306, and 308 along with the information linked to the recordings 204, 304, 306, and 308 in an external database (e.g., in the cloud or on a user device). The security hub may also retrieve the recordings 204, 304, 306, and 308 from the external database. In this manner, the security hub stores any number of recordings for any number of sensors. In some instances, the external database may also store other recordings that were not generated by the security hub. For example, sensor manufacturers or other security systems may store recordings of sensor sounds in the external database to produce a library of recordings. The security hub may then reference the library of recordings when the security hub subsequently detects a sound to determine whether the sound is produced by a sensor that triggered.

FIG. 3B illustrates an example operation 320 performed by the security system 100 of FIG. 1A, according to one embodiment. A security hub or remote keypad (e.g., the security hub 105 or the remote keypad 150 shown in FIG. 1A) may perform the operation 320. For clarity, the security hub will be described as performing the operation 320, but it is understood that the remote keypad may also perform the operation 320. By performing the operation, the security hub stores recordings in internal memory and/or an external database.

In the example of FIG. 3B, the security hub stores the recordings 304, 306, 204, and 308, which the security hub may have sorted as discussed above. The security hub may store the recordings 304, 306, 204, and 308 in an external database 322 (e.g., in the cloud 155 or the user device 165 shown in FIG. 1A). Additionally, or alternatively, the security hub may store the recordings 304, 306, 204, and 308 in a memory 324, which may be an internal memory (e.g., the memory 174 shown in FIG. 1B). By storing the recordings 304, 306, 204, and 308, the security hub may subsequently retrieve and compare the recordings 304, 306, 204, and 308 against detected sounds to determine whether the sounds are produced by a sensor.

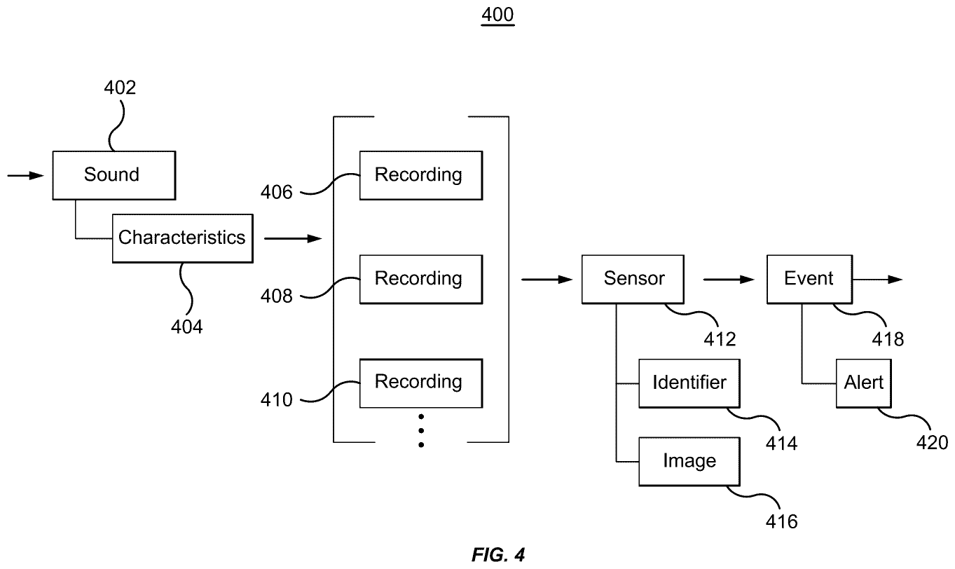

FIG. 4 illustrates an example operation 400 performed by the security system 100 of FIG. 1A, according to one embodiment. A security hub or remote keypad (e.g., the security hub 105 or the remote keypad 150 shown in FIG. 1A) may perform the operation 400. For clarity, the security hub will be described as performing the operation 400, but it is understood that the remote keypad may also perform the operation 400. By performing the operation, the security hub uses recordings to determine when a sensor is triggered.

The security hub begins by detecting a sound 402. The sound 402 may be produced by a sensor when the sensor triggers due to a triggering event. The security hub may use a microphone to capture the sound 402 produced by the sensor. The sensor may not be registered to the security hub. As a result, the sensor may not provide the security hub any identifying information when the sensor triggers.

The security hub may determine a recording that most closely resembles the sound 402 produced by the sensor. For example, the security hub may determine certain characteristics 404 of the sound 402. The characteristics 404 may include an amplitude of the sound 402 and/or a frequency of the sound 402. The security hub may then compare these characteristics 404 with characteristics of previously stored recordings of sounds. These sounds may have been previously sorted based on these characteristics, which may reduce the amount of time it takes for the security hub to determine the recording that most closely resembles the sound 402.

In the example of FIG. 4, the security hub compares the characteristics 404 with the characteristics of recordings 406, 408, and 410. For example, the security hub may determine which of the recordings 406, 408, and 410 has a frequency and/or amplitude that is closest to the frequency and/or amplitude of the sound 402. The security hub may then determine that that recording 406, 408, or 410 most closely resembles the sound 402.

As discussed above, the recordings 406, 408, and 410 may be part of a library of recordings stored in an external database. These recordings 406, 408, and 410 may have been generated by the security hub, another security system, or another service. As a result, the security hub may not be limited to comparing the detected sound 402 against only recordings produced by the security hub. Rather, the security hub may compare the sound 402 against a full library of recordings generated by other security systems or services to determine which sensor produced the sound 402.

After determining the recording that most resembles the sound 402, the security hub determines a sensor 412 that is linked to that recording. Additionally, the security hub may determine an identifier 414 and/or an image 416 that is linked to that recording. In this manner, the security hub determines the sensor 412 that produced the recording that most closely resembles the sound 402. The security hub may then determine that the sensor 412 triggered due to a triggering event and produced the sound 402.

The security hub then generates an event 418, which may also be referred to as a reporting event. The reporting event 418 (e.g., an alarm event) announces or reports that the sensor 412 triggered. For example, if the sensor 412 is a motion sensor, the event 418 may indicate an alarm event for detected motion. As another example, if the sensor 412 is an entry sensor, the event 418 may indicate an alarm event for detected entry. The security hub may also generate an alert 420 for the event. The alert 420 may include textual messages and/or electrical audio signals to announce the event 418. For example, the security hub may communicate text messages or notifications to a user device to report the event 418. As another example, the security hub may produce audio sounds (e.g., using a speaker) to announce the event.

In some embodiments, the security hub reports the event 418 to an external station (e.g., a central monitoring station). In this manner, the security hub may request assistance or help in responding to the event 418. The external station may contact authorities (e.g., police department, fire department, hospital, etc.) to respond to the event 418.

In instances where two identical sensors that produce the same sound are installed in the environment around the security hub, the security hub may still distinguish between the two sensors. For example, the sensors may be installed in different locations and/or at different distances to the security hub. Furthermore, the sensors may have different physical obstacles (e.g., walls, pillars, objects, etc.) between the sensors and the security hub. As a result, the acoustics between the security hub and the sensors may be different for each sensor, which may cause different distortions in the sounds detected by the security hub from each sensor. These distortions may allow the security hub to distinguish the sounds produced by the sensors.

The security hub is not limited to recording the sounds that sensors produce when triggered. For example, the security hub may also record status indicator sounds produced by a sensor. These sounds may indicate any status of the sensor (e.g., sounds indicating that the sensor is running low on battery, that the sensor is active, that the sensor is inactive, that the sensor should be replaced, etc.). The security hub may record these sounds, and the user input may also indicate the status indicated by the sound. When the sensor subsequently produces that sound, the security hub detects the sound and determines the status of the sensor by comparing the produced sound with the recording of the sound. The security hub may then generate an event and alert to report the status of the sensor.

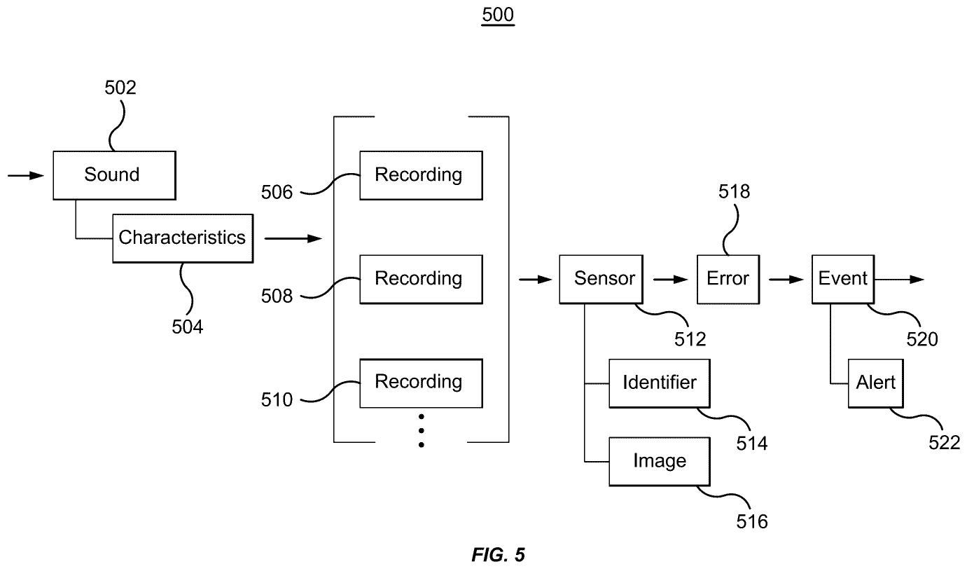

FIG. 5 illustrates an example operation 500 performed by the security system 100 of FIG. 1A, according to one embodiment. A security hub or remote keypad (e.g., the security hub 105 or the remote keypad 150 shown in FIG. 1A) may perform the operation 500. For clarity, the security hub will be described as performing the operation 500, but it is understood that the remote keypad may also perform the operation 500. By performing the operation, the security hub determines when a sensor is experiencing an error.

The security hub begins by detecting a sound 502. The sound 502 may be produced by a sensor when the sensor triggers. The security hub may use a microphone to capture the sound 502 produced by the sensor. The sensor may not be registered to the security hub. As a result, the sensor may not provide the security hub any identifying information when the sensor triggers. In the example of FIG. 5, the sound 502 may be a sound that the sensor produces when the triggering event is a fault or error experienced by the sensor (e.g., low battery, tampering, connection loss, etc.).

The security hub may determine a recording that most closely resembles the sound 502 produced by the sensor. For example, the security hub may determine certain characteristics 504 of the sound 502. The characteristics 504 may include an amplitude of the sound 502 and/or a frequency of the sound 502. The security hub may then compare these characteristics 504 with characteristics of previously stored recordings of sounds. These sounds may have been previously sorted based on these characteristics, which may reduce the amount of time it takes for the security hub to determine the recording that most closely resembles the sound 502.

In the example of FIG. 5, the security hub compares the characteristics 504 with the characteristics of recordings 506, 508, and 510. For example, the security hub may determine which of the recordings 506, 508, and 510 has a frequency and/or amplitude that is closest to the frequency and/or amplitude of the sound 502. The security hub may then determine that that recording 506, 508, or 510 most closely resembles the sound 502.

As discussed above, the recordings 506, 508, and 510 may be part of a library of recordings stored in an external database. These recordings 506, 508, and 510 may have been generated by the security hub, another security system, or another service. As a result, the security hub may not be limited to comparing the detected sound 502 against only recordings produced by the security hub. Rather, the security hub may compare the sound 502 against a full library of recordings generated by other security systems or services to determine which sensor produced the sound 502.

After determining the recording that most resembles the sound 502, the security hub determines a sensor 512 that is linked to that recording. Additionally, the security hub may determine an identifier 514 and/or an image 516 that is linked to that recording. In this manner, the security hub determines the sensor 512 that produced the recording that most closely resembles the sound 502. The security hub may then determine that the sensor 512 triggered and produced the sound 502.

The security hub may determine that the sensor 512 is experiencing an error 518 based on discrepancies between the sound 502 and the recording that most closely resembles the sound 502. For example, the security hub may determine differences between the sound 502 and the recording (e.g., differences in frequency, differences in amplitude, etc.). The security hub may then compare these differences against thresholds and determine whether the differences exceed the thresholds. If the differences exceed the thresholds, the security hub may determine that the sensor 512 is experiencing the error 518. For example, the security hub may determine that the sensor 512 is running low on battery power. As another example, the security hub may determine that the sensor 512 is being tampered with and/or being moved to another location, which may affect the environment around the sensor 512 and/or the acoustics of the sensor 512.

The security hub then generates an event 520 (which may also be referred to as a reporting event) that announces or reports that the sensor 512 is experiencing the error 518. For example, if the sensor 512 is running low on battery power, the event 520 may indicate a low battery event. As another example, if the sensor 512 is being tampered with or moved, the event 520 may indicate a tamper event. The security hub may also generate an alert 522 for the event. The alert 522 may include textual messages and/or audio signals to announce the event 520. For example, the security hub may communicate text messages or notifications to a user device to report the event 520. As another example, the security hub may produce audio signals (e.g., using a speaker) to announce the event. In this manner, the security hub identifies the triggering event that caused the sensor to produce the sound 502.

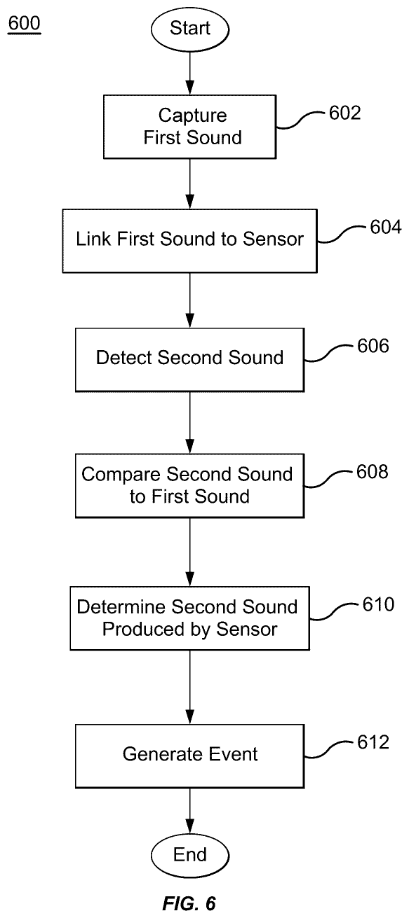

FIG. 6 is a flowchart of an example method 600 performed by the security system 100 of FIG. 1A, according to one embodiment. A security hub or remote keypad (e.g., the security hub 105 or the remote keypad 150 shown in FIG. 1A) may perform the method 600. For clarity, the security hub will be described as performing the method 600, but it is understood that the remote keypad may also perform the method 600. By performing the method 600, the security hub identifies a sensor that triggered based on the sound produced by the sensor.

At 602, the security hub detects a first sound produced by a sensor. The sensor may not be registered to the security hub (e.g., due to the sensor being a third-party sensor). The security hub may use a microphone to capture the first sound. At 604, the security hub links the first sound to the sensor. For example, the security hub may generate a recording of the first sound and present a message requesting user input to identify the sensor that produced the first sound. The user input may include an identifier (e.g., name) of the sensor and/or an image of the sensor. The security hub may then link the identifier and/or the image with the first sound. For example, the security may store the recording along with the identifier and/or image (e.g., internally in the security hub and/or in an external database). As another example, the security hub may store in a data structure (e.g., a table) an indication that the recording is linked to the identifier and/or the image.

At 606, the security hub detects a second sound. The security hub may use the microphone to detect the second sound. The second sound may have certain characteristics. For example, the second sound may have certain frequencies or amplitudes. At 608, the security hub compares the second sound to the first sound. For example, the security hub may compare the second sound to the stored recording of the first sound. The security hub may determine that the characteristics of the second sound are similar to the characteristics of the first sound in the recording. In response, the security hub may determine that the second sound is produced by the sensor at 610. In response, the security hub generates an event (e.g., reporting event) at 612. For example, the security hub may generate an alarm event that indicates that the sensor triggered. The security hub may then communicate an alert indicating the event. For example, the security hub may communicate a text message to a user device, produce an audio signal (e.g., a siren), and/or communicate a message to a central monitoring station. In this manner, the security hub may identify and monitor a sensor, even though the sensor is not registered to the security hub.

In summary, the security system 100 (e.g., a home or business security system) uses sounds produced by sensors to identify the sensors. The security system 100 may use a microphone to capture or detect a sound produced by a sensor. The security system 100 may then record the sound and link the recorded sound to a sensor (e.g., identified by an owner or user of the security system 100). When the sensor produces a sound, the security system 100 may detect the sound and compare the detected sound against previous recordings. The security system 100 may then generate a reporting event based on the nature of sensor and/or the state of the security system 100 (e.g., an alarm event for a smoke detector or for a motion sensor when the security system is armed). The reporting event may indicate that the identified sensor triggered. The security system 100 may also use the sound itself to determine the nature of the triggering event, such as whether the sensor was an alarm event, or some other reportable event, like a trouble condition with the sensor itself (such as a fault or low battery condition).

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments, and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method, or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wired, optical fiber cable, RF, etc., or any suitable combination of the foregoing.

Computer program code for carrying out operations for embodiments of the present disclosure may be written in any combination of one or more programming languages, including an object-oriented-programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A security system comprising:
a microphone;
one or more memories; and
one or more processors communicatively coupled to the one or more memories, the one or more processors configured to, individually or collectively, perform an operation comprising:
capturing, using the microphone, a first sound produced by a sensor;
linking the first sound to the sensor;
detecting, using the microphone and after linking the first sound to the sensor, a second sound;
determining, by comparing the second sound to the first sound, that the second sound is produced by a triggering of the sensor by a triggering event; and
in response to determining that the second sound is produced by the triggering of the sensor, generating a reporting event based on the triggering of the sensor.

2. The security system of claim 1, wherein linking the first sound to the sensor comprises storing a recording of the first sound.

3. The security system of claim 2, wherein the operation further comprises sorting a plurality of recordings comprising the recording of the first sound based on a characteristic of the first sound.

4. The security system of claim 3, wherein the characteristic comprises at least one of a frequency of the first sound or an amplitude of the first sound.

5. The security system of claim 2, wherein the operation further comprises communicating the recording of the first sound to an external database.

6. The security system of claim 1, further comprising a speaker, wherein generating the reporting event comprises generating an audio alert using the speaker.

7. The security system of claim 1, wherein the operation further comprises communicating the reporting event to an external station.

8. The security system of claim 1, wherein the reporting event is an alarm event.

9. The security system of claim 8, wherein the sensor comprises at least one of a smoke detector, a carbon monoxide detector, or a moisture sensor.

10. The security system of claim 1, wherein the triggering event is an error experienced by the sensor.

11. A method comprising:
capturing, using a microphone, a first sound produced by a sensor;
linking the first sound to the sensor;
detecting, using the microphone and after linking the first sound to the sensor, a second sound;
determining, by comparing the second sound to the first sound, that the second sound is produced by a triggering of the sensor by a triggering event; and
in response to determining that the second sound is produced by the triggering of the sensor, generating a reporting event based on the triggering of the sensor.

12. The method of claim 11, wherein linking the first sound to the sensor comprises storing a recording of the first sound.

13. The method of claim 12, further comprising sorting a plurality of recordings comprising the recording of the first sound based on a characteristic of the first sound.

14. The method of claim 13, wherein the characteristic comprises at least one of a frequency of the first sound or an amplitude of the first sound.

15. The method of claim 12, further comprising communicating the recording of the first sound to an external database.

16. The method of claim 11, wherein generating the reporting event comprises generating an audio alert using a speaker.

17. The method of claim 11, further comprising communicating the reporting event to an external station.

18. The method of claim 11, wherein the reporting event is an alarm event.

19. The method of claim 11, wherein the triggering event is an error experienced by the sensor.

20. A non-transitory computer readable medium storing instructions that, when performed by one or more processors, cause the one or more processors to, individually or collectively, perform an operation comprising:
capturing, using a microphone, a first sound;
comparing the first sound to a recording of a second sound produced by a sensor to determine that the second sound is produced by a triggering of the sensor by a triggering event; and
in response to determining that the second sound is produced by the triggering of the sensor, generating a reporting event based on the triggering of the sensor.
